(19) United States
(12) Patent Application Publication
(10) Pub. No.: US 2017/0225306 A1
(43) Pub. Date: Aug. 10, 2017

(54) BOLT ADJUSTMENT DEVICE

(71) Applicant: ANSALDO ENERGIA IP UK LIMITED, London (GB)

(72) Inventors: Ernst VOGT, Remigen (CH); Fabian GUBELMANN, Buchs (CH); Thomas KARRER, Eglisau (CH); Josef HAFNER, Künten (CH); Roman PETER, Hottwil (CH)

(73) Assignee: ANSALDO ENERGIA IP UK LIMITED, London (GB)

(21) Appl. No.: 15/428,522

(22) Filed: Feb. 9, 2017

(30) Foreign Application Priority Data
Feb. 9, 2016 (EP) 16154930.8

(51) Int. Cl. B25B 23/14; B25B 23/00; B25B 23/10

(52) U.S. Cl. CPC B25B 23/14; B25B 23/108; B25B 23/0064; B25B 23/0007

(57) ABSTRACT

A bolt adjustment device having a body, a clamping mechanism and an attachment point. The body extends in a longitudinal direction from a first end to a second end, the body having a cavity extending into the body in the longitudinal direction from the first end. The cavity can accommodate a thread during use of the bolt adjustment device. A step in the cavity is configured and arranged to engage with a nut when in use. A torque imparted on the attachment point will impart a torque to the bolt adjustment device. The clamping mechanism is attached to the attachment point such that the clamping mechanism clamps the nut in the cavity when torque is imparted on the clamping device.

### PRIORITY CLAIM

This application claims priority from Italian patent application no. 16154930.8 filed on Feb. 9, 2016, the disclosure of which is incorporated by reference.

### TECHNICAL FIELD

The present disclosure relates to bolt adjustment devices, and particularly to bolt adjustment devices with a body, a clamping mechanism and an attachment point for imparting a torque on the bolt adjustment device

### BACKGROUND OF THE INVENTION

The outer casing of gas turbines is generally split into an upper half and a lower half, with the two halves joined together using bolts. During events such as gas turbine maintenance it is common to have to remove the bolts to take apart the two halves and then put the bolts back later on during reassembly of the gas turbine. These bolts currently have to be attached with a method including a measurement step and a pretightening step, and since a single gas turbine requires a considerable number of bolts to hold together the two halves, this is a time-consuming task. It has been appreciated that improvements can be made.

### SUMMARY OF THE INVENTION

The invention is defined in the appended independent claims to which reference should now be made. Advantageous features of the invention are set forth in the dependent claims.

A first aspect of the invention describes a bolt adjustment device comprising a body, a clamping mechanism and an attachment point, in which the body extends in a longitudinal direction from a first end to a second end, the body comprising a cavity extending into the body in the longitudinal direction from the first end, the cavity being configured and arranged to accommodate a thread during use of the bolt adjustment device and a step in the cavity at the first end, the step being configured and arranged to engage with a nut when in use; in which a torque can be imparted on the attachment point to impart a torque to the bolt adjustment device; and in which the clamping mechanism is attached to the attachment point such that the clamping mechanism clamps said nut in the cavity when a torque is imparted on the clamping device. Preferably, the clamping mechanism comprises a disc adjacent to the body at the second end, the disc comprising a face facing the second end of the body and a groove set into the face, the groove extending in a radial direction and a circumferential direction relative to the longitudinal direction; and a crank comprising a first arm extending through the body from the first end to the second end, the first arm being configured and arranged to rotate relative to the body, the first arm comprising a clamping portion at the first end and a second arm attached to the first arm at the second end, the second arm being moveably connected to the groove so that the groove acts on the second arm to move the second arm when said torque is applied to the bolt adjustment device, thereby rotating the first arm and actuating the clamping portion of the first arm to clamp said nut in the cavity at the first end.

The bolt adjustment device can standardise bolt adjustment, particularly when doing up a bolt. The bolt adjustment device can allow a nut to be screwed onto a thread and for the thread to protrude a predetermined length without the need for a measurement step during the process. The bolt adjustment device can be compact enough to fit in the limited space around the bolt on a gas turbine.

Preferably, the bolt adjustment device comprises a torque limiter attached between the attachment point and the clamping mechanism. The torque limiter can provide appropriate pretightening without overtightening, and can reduce or remove the risks of overtightening and of damaging tools and injuring tool operators.

Preferably, the bolt adjustment device comprises a window in the body between the first end and the second end. This can reduce the mass (and therefore the weight) of the bolt adjustment device.

Preferably, the groove describes a spiral shape. Preferably, the bolt adjustment device comprises two cranks and two grooves or three cranks and three grooves. This can improve the clamping.

Preferably, the cross-section of the clamping portion of the first arm in a plane perpendicular to the longitudinal direction is a circle with a circular segment removed.

Preferably, the bolt adjustment device comprises a crank recess in the second end of the body, and the second arm is in the crank recess. The crank recess can reduce the size of the device.

A second aspect provides a method of tightening a bolt, the bolt comprising a thread and a nut, the method comprising the steps of placing a bolt adjustment device as described above on the nut and applying a torque to the bolt adjustment device to screw the nut onto or off of the thread. Preferably, the torque is applied to the bolt adjustment device to screw the nut onto the thread, and, after the nut is a predetermined distance onto the thread, the torque is applied to the bolt adjustment device to screw on both the thread and the nut. This can result in a nut tightened to a predefined level and a thread protruding beyond the nut by a predefined distance, such as that shown in FIG. 10. This can simplify and speed up the process of reassembling a gas turbine by reducing the lead time associated with attaching the bolts, for example by removing the need for a thread length measurement step.

### BRIEF DESCRIPTION OF THE DRAWINGS

An embodiment of the invention will now be described by way of example only and with reference to the accompanying drawings in which:

FIG. 1 shows a perspective view of a bolt adjustment device;

FIGS. 2 and 3 show partly exploded perspective views of the bolt adjustment device of FIG. 1;

FIG. 4 shows a top view of the second end of a bolt adjustment device body along with a bottom view of a disc for comparison;

FIG. 5 shows a perspective view of the parts in FIG. 4, with a crank also removed from the body;

FIG. 6 shows a perspective view of the first end of the bolt adjustment device of FIG. 4, showing the cavity and the step;

FIG. 7 shows a perspective view of the assembled body, cranks and disc of

FIG. 8 shows a perspective view of a bolt adjustment device on a bolt;

FIG. 9 shows a bottom view of a disc with an alternative groove configuration; and

FIG. 10 shows a cross-section of a bolt (thread and nut).

### DETAILED DESCRIPTION OF THE PREFERRED EMBODIMENTS

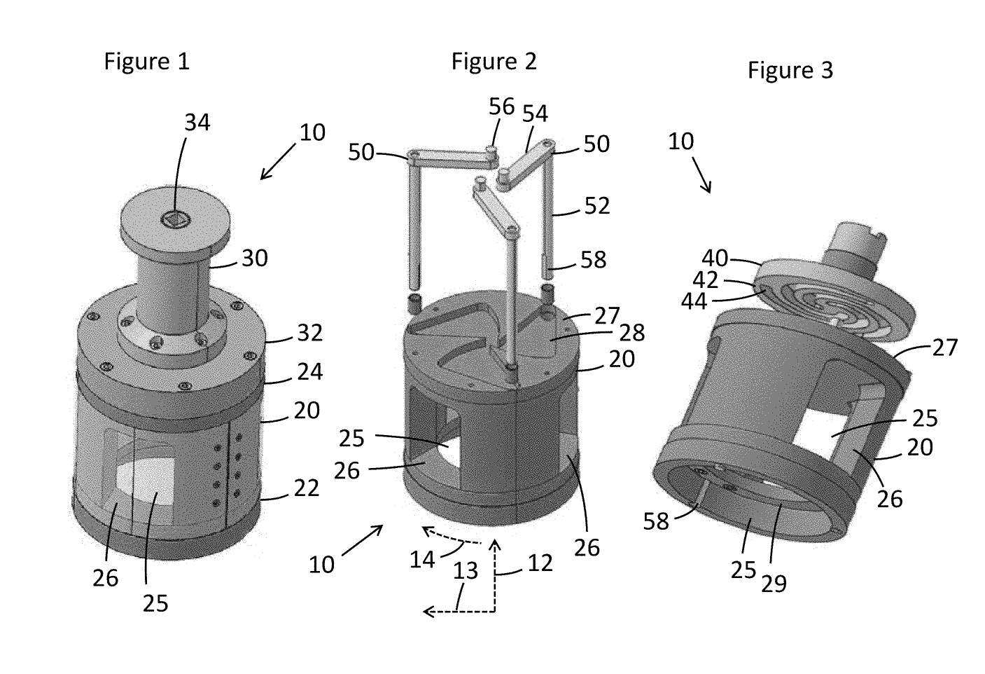

FIG. 1 shows an example of a bolt adjustment device 10. The bolt adjustment device comprises a body 20, a clamping mechanism (not visible in FIG. 1) and a handle 30. The body has a cylindrical shape and extends in a longitudinal direction from a first end 22 to a second end 24. A casing 32 is attached to the second end of the body and extends around a part of the clamping mechanism. The handle 30 is attached at the other side of the casing 32 from the body 20. The handle comprises an attachment point 34 for a drive. A cavity (recess) 25 in the body 20 is also visible in FIG. 1 through a window 26 in the body 20. The cavity 25 extends from an opening in the first end 22 up to the second end 24.

FIGS. 2 and 3 show internal components that make up the clamping mechanism of the bolt adjustment device. In general, the clamping mechanism is intended to clamp a nut when a torque (a moment of force) is applied to the bolt adjustment device to screw up the nut. The clamping mechanism comprises a disc 40 and three cranks 50. The disc is arranged adjacent to the second end 24 of the body 20 and has a face 42 facing the second end. grooves 44, which in this case are spirals, are set into the face 42. A torque limiter (not directly visible) may also be provided, and would generally be attached in the handle 30 between the attachment point 34 and the disc 40.

The second end 24 of the body also has a face 27 facing towards the face 42. A crank recess 28 is set into the face 27 of the second end. The crank comprises a first arm 52 and a second arm 54. The first arm extends longitudinally through the body 20 from the first end 22 to the second end 24, and is attached to the second arm at the second end 24. At the first end 22, a flat portion 58 is provided for clamping a nut.

The second arm extends perpendicular to the first arm and parallel to the face 27 of the second end. The second arm comprises a protrusion 56 extending in the longitudinal direction; this protrusion engages the groove 44.

In FIG. 3, the structure of the cavity 25 at the first end can also be seen. The main portion of the cavity describes a cylinder. At the first end, where the cavity has an opening, the cavity is wider so as to accommodate a nut. The result is a step 29 within the cavity, where the cavity becomes wider. A nut can enter the cavity only up to the step 29, whereas the thread associated with the nut can also enter into the main portion of the cavity.

The disc is connected to the attachment point 34. When the bolt adjustment device is fully assembled, the disc 40 and crank 50 are able to rotate relative to the body 20. The disc and crank can also move relative to one another and are moveably connected to one another, with the disc rotating about the longitudinal axis of the bolt adjustment device (and of the body) and the crank rotating about the longitudinal axis of the first arm 52. The extent of movement of the second arm defines a circular sector (a pie-slice shaped area). This circular sector is also the shape associated with the crank recess 28, with three circular sectors provided, one for each of the cranks. The circular sectors are centred roughly at the longitudinal axis of the first arm 52.

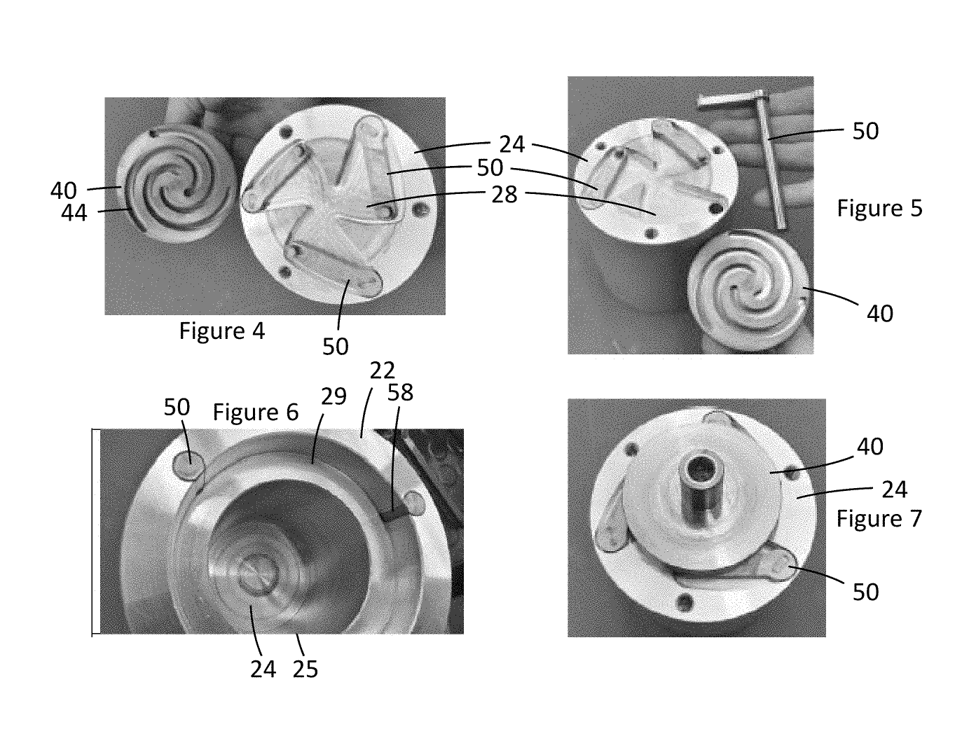

FIGS. 4 to 7 show another example of a bolt adjustment device from various angles and in various stages of assembly. In FIG. 4, the second end 24 of the body 20 can be seen with three cranks in place inside the body, along with a disc 40 with the side with grooves 44 face up. In FIG. 5, the same parts can be seen, but this time with one of the cranks removed from the body. In FIG. 6, part of the first end 22 can be seen, along with the cavity 25 extending to the second end 24. The step 29 in the cavity and the flat portion 58 on the first ends of the cranks can also be seen. In FIG. 7, the body, cranks and disc can be seen assembled.

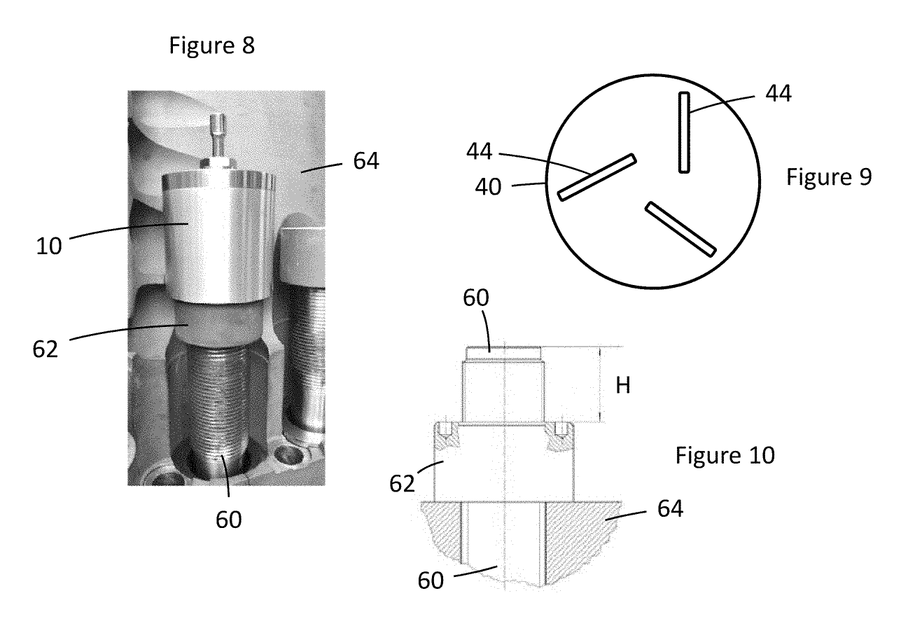

FIG. 8 shows a bolt adjustment device on a bolt. The thread 60 and the nut 62 of the bolt can be seen, along with the outer casing 64 of a gas turbine in the background.

FIG. 9 shows an alternative design for the grooves 44 in the disc. Instead of a spiral pattern as shown in for example FIG. 4, straight grooves are provided. The grooves extend both in the radial direction 13 and in the circumferential direction 14.

For reference, FIG. 10 shows a thread 60 and a nut 62 that have been done up. The height H corresponds to the depth of the cavity from the step 29 to the wall at the second end 24.

To use the bolt adjustment device to tighten up a bolt, the bolt adjustment device is first put on the nut with the nut at the top of the thread. The bolt adjustment device is then sitting with the nut touching the step 29 in the cavity. A drive (for example a screwdriver or an impact driver, such as an air driven angle impact driver) or another means of providing torque can then be attached to the bolt adjustment device and used to do up the nut. As soon as torque is applied to the bolt adjustment device it results in the disc rotating, which also rotates the cranks. The cranks then grip the nut and the nut is rotated, threading it onto the thread. As the nut is turned down onto the thread, the bolt adjustment device goes with it, and as a result the thread extends into the cavity in the bolt adjustment device.

After a predefined number of turns (this is set by the depth of the cavity in the bolt adjustment device), the end of the thread contacts the wall of the cavity at the second end of the body of the bolt adjustment device. At this point, the thread and the nut stop moving relative to one another, and the entire bolt is turned into the outer casing.

Once the nut has reached the counter surface (the outer casing surface in the example of a gas turbine outer casing), a torque limiter in the bolt adjustment device stops the nut from being overtightened (overtorqued). The drive is then stopped, with the result that the cranks can relax back to their original position, relinquishing their grip on the nut. The bolt adjustment device can then be lifted off the bolt.

The result is that the nut is tightened a predefined amount based on the torque limiter settings and that the thread protrudes a predefined amount beyond the nut. The thread protrusion is set by the depth of the cavity as mentioned above, and is the distance from the step 29 to the back wall of the cavity at the second end 24.

Largely the same process can be followed to undo a bolt, with the disc 40 and the crank 50 of the clamping mechanism in the bolt adjustment device rotating in the opposite direction.

The description above gives the example of a bolt adjustment device being used for a gas turbine. As well as being for a gas turbine, a bolt adjustment device of this type can also be used on other machines. Particular examples include steam turbines and generators, where upper and lower housings also have to be fixed together in a similar fashion. The invention is also not limited to use on bolts connecting the upper and lower housings, and may also be useful for bolts elsewhere in gas turbines and other machines.

A gas turbine will typically include bolts of various sizes, and a separate size of bolt adjustment device would typically be needed for each size. The bolt adjustment device can be provided in a number of different sizes to cater for this.

A gas turbine comprises a compressor, a combustor downstream of the compressor and a turbine downstream of the combustor. An outer casing (outer housing) normally extends around the outside of the compressor and the turbine.

Various parts and structures of the bolt adjustment device are described as cylindrical, but this is not the only option, and some or all of these cylindrical parts and structures may be shaped in other ways. Some examples of alternative shapes are included within the alternatives listed below.

One particular modification that can be made is the reduction of the weight of the bolt adjustment device by the reduction of non-structural portions of the bolt adjustment device. One example can be seen in the Figures; in FIGS. 1 to 3, there is a window 26 in the body 20. This can save weight without affecting the performance of the bolt adjustment device. Other parts of the bolt adjustment device could also be modified in a similar manner.

For reference, FIG. 2 shows the longitudinal direction 12 (the longitudinal axis extends through the centre of the bolt adjustment device in the longitudinal direction), the radial direction 13 and the circumferential direction 14.

The body 20 is shown as cylindrical in the examples above, but may also be other shapes; for example, the body may have a hexagonal profile in the plane perpendicular to the longitudinal axis, or the body may have an irregular shape to fit around any parts of the gas turbine that would otherwise be in the way of the bolt adjustment device when in use.

The first end 22 and the second end 24 are portions of the body at each end of the body in the longitudinal direction. The first end comprises the step 29.

The cavity 25 can be various shapes. The cavity can be considered as being divided into two parts by the step 29. In the portion of the cavity that is closer to the second end 24 than the step, the cavity is intended to allow a thread to pass into the cavity up to the second end during use. The portion of the cavity on the other side of the step also allows passage of the thread, and additionally allows ingress of a nut up to the step so that the nut can be clamped by the flat portion 58 of the crank 50. The portion of the cavity that admits the nut, which is at the first end, may be various shapes to work with different shapes of nut.

During a design phase, the thickness of the second end may be adjusted to adjust the depth of the cavity 25 and therefore the extent to which the thread sticks out beyond the nut after use of the bolt adjustment device; alternatively, the length of the body itself can be adjusted during a design phase. The body 20 can also be seen as a wall extending around the cavity 25, and the cavity can be greater in volume than the volume of the wall itself.

The window 26 is optional and can provide weight savings as mentioned above. The window can also make it possible to see the thread moving up inside the cavity 25. The window may be covered, for example by a transparent material; this can provide a safer bolt adjustment device.

The crank recess 28 is optional, and alternatively the second arms 54 of the cranks may sit in a gap between the body 20 and the disc 40. The crank recesses may be connected together as a single recess as shown in the Figures, or alternatively the crank recess for each crank may be separate and spaced apart from the other crank recesses.

Reductions in weight could be achieved by extending the crank recesses beyond the path covered by the second arms 54.

The step 29 is a feature that limits how far a nut can extend into the cavity 25. As such, various modifications to the design of the step are possible; for example, the step may extend around only part of the body in the circumferential direction 14.

The handle 30 and the casing 32 are optional, but can provide a more practical tool and can have environmental health and safety benefits.

An attachment point 34 can be provided at which a torque may be imparted to rotate the bolt adjustment device in the circumferential direction 14. Other forms of attachment point may also be provided depending on how the torque is delivered. The attachment point needs to be attached directly to the disc or on a part attached to the disc so that torque can be transferred to the clamping mechanism (the disc and the cranks) as well as to the body for transfer to the nut.

The disc 40 is shown as a circular shape in the plane perpendicular to the longitudinal axis but does not have to be circular and may alternatively be hexagonal, for example. The attachment point would generally be attached to the disc at a point distal from the face 27 and the grooves 44.

The face 27 is generally planar apart from one or more grooves 44. The one or more grooves 44 are provided in the face to fit with one or more cranks 50. The grooves need to be structured so that the torque imparted when the bolt adjustment device is used pushes the protrusions on the cranks towards the centre of the disc or away from the centre of the disc, thereby rotating the cranks and clamping the nut. In general, this is achieved by grooves that extend both in the radial and circumferential directions, such as those in FIGS. 4 and 9. When looking at the grooves on the disc as shown in FIGS. 4, the grooves spiral towards the centre when moving around the disc in a clockwise direction. Similarly in FIG. 9, the grooves move towards the centre when moving around the disc in a clockwise direction, although grooves that move towards the centre when moving around the disc in an anticlockwise direction could also be used; this would result in the cranks rotating in the opposite direction. Preferably, a neutral position (i.e. the position when no torque is being applied and therefore no clamping is occurring) for the bolt adjustment device should have the protrusion 56 somewhere in the middle of the groove rather than at one end of the groove. This can allow the bolt adjustment device to be used for both doing up and undoing a nut.

The cranks 50 are coupled to the grooves 44, typically by protrusions 56 slotted into the grooves although the second arms may also fit directly into the grooves. The first arm 52 is shown as cylindrical within a cylindrical hole in the body, but may alternatively be another shape, such as hexagonal, in which case the flat portion would be part of the hexagonal shape. The flat portion 58 is provided as a clamping portion of the first arm 52. Use of a flat portion is not essential, and other shapes can also provide the same effect. As long as the cross-section of the clamping portion of the first arm is not circular in the plane perpendicular to the longitudinal direction 12, a clamp can be provided. The clamping portion would normally be flush with the wall of the cavity when no torque is being applied to the bolt adjustment device; this allows the bolt adjustment device to be placed on a nut. In FIG. 6, for example, the clamping portion of the first arm 52 of the crank can be seen. The cross-section of the clamping portion in the plane perpendicular to the longitudinal direction 12 is a circle with a circular segment removed.

The protrusions 56 are generally at the end of the second arm distal from the connection between the first arm and the second arm.

A bolt normally comprises a thread and a nut. The thread may be part of stud (a bolt with a thread at both ends).

The clamping mechanism described above is just an example, and other designs of clamping mechanism could also be used. In another example of a clamping mechanism, an eccentric control disc or discs (that is, a circular disc fixed to a rotating axle with its centre offset from that of the axle, sometimes known as an eccentric) is used instead of a disc 40 with grooves 44. The crank 50 would engage with the eccentric control disc, and the eccentric control disc would be attached to the attachment point 34. In a further example of a clamping mechanism, the second arm 54 of the crank is articulated. In both these examples the second arm 54 of the crank still engages with the disc, for example with a protrusion 56 on the second arm engaging with a recess or a circumferential groove (that is, a groove extending around part or all of the disc at a constant distance from the centre of the disc) in the disc rather than with grooves 44.

Various modifications to the embodiments described are possible and will occur to those skilled in the art without departing from the invention which is defined by the following claims.

REFERENCE NUMERALS

| | |
|---|---|
| 10 | bolt adjustment device |
| 12 | longitudinal direction |
| 13 | radial direction |
| 14 | circumferential direction |
| 20 | body |
| 22 | first end |
| 24 | second end |
| 25 | cavity/recess |
| 26 | window |
| 27 | face |
| 28 | crank recess |
| 29 | step |
| 30 | handle |
| 32 | casing |
| 34 | attachment point |
| 40 | disc |
| 42 | face |
| 44 | groove |
| 50 | crank |
| 52 | first arm |
| 54 | second arm |
| 56 | protrusion |
| 58 | flat portion |
| 60 | thread |
| 62 | nut |
| 64 | outer casing |

1. A bolt adjustment device comprising:
a body;
a clamping mechanism; and
an attachment point,
wherein the body extends in a longitudinal direction from a first end to a second end, the body having:
a cavity extending into the body in the longitudinal direction from the first end, the cavity being configured and arranged to accommodate a thread during use of the bolt adjustment device, and
a step in the cavity at the first end, the step being configured and arranged to engage with a nut when in use;
wherein the attachment point is configured to receive a torque imparted on the attachment point and to thereby impart a torque to the bolt adjustment device; and
wherein the clamping mechanism is attached to the attachment point such that during use the clamping mechanism will clamp a nut in the cavity when a torque is imparted on the clamping device.

2. The bolt adjustment device of claim 1, in which the clamping mechanism comprises:
a disc adjacent to the body at the second end, the disc comprising having:
a face facing the second end of the body and a groove set into the face, the groove extending in a radial direction and a circumferential direction relative to the longitudinal direction; and
a crank having:
a first arm extending through the body from the first end to the second end, the first arm being configured and arranged to rotate relative to the body, the first arm having a clamping portion at the first end; and
a second arm attached to the first arm at the second end, the second arm being moveably connected to the groove so that the groove will act on the second arm to move the second arm when said torque is applied to the bolt adjustment device, thereby rotating the first arm and actuating the clamping portion of the first arm to clamp said nut in the cavity at the first end.

3. The bolt adjustment device of claim 1, comprising,
a torque limiter attached between the attachment point and the clamping mechanism.

4. The bolt adjustment device of claim 1, comprising,
a window in the body between the first end and the second end.

5. The bolt adjustment device of claim 1, wherein the groove is formed with a spiral shape.

6. The bolt adjustment device of claim 1, comprising:
two cranks and two grooves, or three cranks and three grooves.

7. The bolt adjustment device of claim 1, wherein a cross-section of the clamping portion of the first arm in a plane perpendicular to the longitudinal direction is a circle with a circular segment removed.

8. The bolt adjustment device of claim 1, comprising:
a crank recess in the second end of the body, the second arm being located in the crank recess.

9. A method of tightening a bolt, the bolt having a thread and a nut, via a bolt adjustment device having:
a body;
a clamping mechanism; and
an attachment point,
wherein the body extends in a longitudinal direction from a first end to a second end, the body having:
a cavity extending into the body in the longitudinal direction from the first end, the cavity being configured and arranged to accommodate a thread during use of the bolt adjustment device; and
a step in the cavity at the first end, the step being configured and arranged to engage with a nut when in use;
wherein the attachment point is configured to receive a torque can be imparted on the attachment point and to thereby impart a torque to the bolt adjustment device; and wherein the clamping mechanism is attached to
the attachment point such that during use the clamping mechanism will clamp a nut in the cavity when a torque is imparted on the clamping device;
the method comprising:
placing the bolt adjustment device on the nut; and
applying a torque to the bolt adjustment device to screw the nut onto or off of the thread.

10. The method of claim 9, wherein the torque is applied to the bolt adjustment device to screw the nut onto the thread, the method comprising:
after the nut is a predetermined distance onto the thread, the torque is applied to the bolt adjustment device to screw on both the thread and the nut.
